(19) United States
(12) Patent Application Publication
(10) Pub. No.: US 2023/0388737 A1
(43) Pub. Date: Nov. 30, 2023

(54) INFERRING CHARACTERISTICS OF PHYSICAL ENCLOSURES USING A PLURALITY OF AUDIO SIGNALS

(71) Applicant: SHURE ACQUISITION HOLDINGS, INC., Niles, IL (US)

(72) Inventors: Daniel Law, Glencoe, IL (US); Michelle Ansai, Niles, IL (US); Dusan Veselinovic, Niles, IL (US); Bijal Joshi, Niles, IL (US)

(21) Appl. No.: 18/324,558

(22) Filed: May 26, 2023

Related U.S. Application Data
(60) Provisional application No. 63/346,668, filed on May 27, 2022.

(51) Int. Cl. H04S 7/00; H04R 5/027; H04R 3/00; H04S 3/00

(52) U.S. Cl. CPC H04S 7/305; H04R 5/027; H04R 3/005; H04S 3/008; H04S 2400/01; H04S 2400/15

(57) ABSTRACT

Various embodiments of the present disclosure provide methods, apparatus, systems, devices, and/or the like for inferring characteristics of a physical enclosure using a plurality of audio signals. The plurality of audio signals may be processed using a feature extraction framework to generate structured audio event data sets, which may be processed using an audio event framework to determine the characteristics of the physical enclosure.

### CROSS-REFERENCE TO RELATED APPLICATIONS

The present application claims priority to U.S. Provisional Application Ser. No. 63/346,668, titled “INFERRING CHARACTERISTICS OF PHYSICAL ENCLOSURES USING A PLURALITY OF AUDIO SIGNALS,” filed May 27, 2022, the entire contents of which are incorporated herein by reference in their entirety.

### BACKGROUND

Applicant has identified many deficiencies and problems associated with existing methods, apparatus, and systems related to reducing defects of audio signal samples. Through applied effort, ingenuity, and innovation, many of these identified deficiencies and problems have been solved by developing solutions that are configured in accordance with embodiments of the present disclosure, many examples of which are described in detail herein.

### BRIEF SUMMARY

In general, embodiments of the present disclosure provide methods, apparatus, systems, devices, and/or the like for inferring the characteristics of a physical enclosure and/or objects or audio sources therein by applying models of a feature extraction framework and audio event framework to a plurality of audio signals.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure. It will be appreciated that the scope of the disclosure encompasses many potential embodiments in addition to those here summarized, some of which will be further described below and embodied by the claims appended herein.

### BRIEF DESCRIPTION OF THE DRAWINGS

Having thus described some embodiments in general terms, references will now be made to the accompanying drawings, which are not necessarily drawn to scale, and wherein:

FIG. 1 is an example system architecture within which embodiments of the present disclosure may operate.

FIG. 2 is an example audio signal processing apparatus configured to apply a feature extraction framework and an audio event framework in accordance with one embodiment of the present disclosure.

FIGS. 3A, 3B, and 3C illustrate example feature extraction frameworks which comprise various models in accordance with one embodiment of the present disclosure.

FIG. 4 illustrates an example architecture included in the feature extraction framework in accordance with one embodiment of the present disclosure.

FIG. 5 illustrates an example U-Net architecture for optional inclusion in the feature extraction framework, in accordance with one or more embodiments disclosed herein.

FIG. 6 illustrates an example downsampling layer of an architecture configured in a U-Net architecture in accordance with one or more embodiments disclosed herein.

FIG. 7 illustrates an example upsampling layer of an example architecture configured in a U-Net architecture in accordance with one or more embodiments disclosed herein.

FIGS. 8A-B illustrate example audio event frameworks, in accordance with one embodiment of the present disclosure.

FIGS. 9A-B depict operational examples of structured audio event data set representations in accordance with one embodiment of the present disclosure.

FIG. 10 depicts an operational example of an audio event summary statistics representation in accordance with one embodiment of the present disclosure.

FIG. 11 depicts a schematic illustration of an example audio signal processing apparatus configured in accordance with one embodiment of the present disclosure.

### DETAILED DESCRIPTION OF VARIOUS EMBODIMENTS

Various embodiments of the present disclosure are described more fully hereinafter with reference to the accompanying drawings, in which some, but not all embodiments of the disclosure are shown. Indeed, the disclosure may embody in many different forms and should not be construed as limited to the embodiments set forth herein. Rather, these embodiments are provided so that this disclosure will satisfy applicable legal requirements.

### Overview

The present disclosure addresses technical problems associated with accurately, efficiently and/or reliably inferring characteristics of a physical enclosure, any objects within the physical enclosure, the environment of the physical enclosure, and/or inferred dynamic positions of audio sources within the physical enclosure using a plurality of audio or other signals captured within the physical enclosure. The disclosed techniques can be implemented by an audio processing system to provide improved denoising, echo cancellation, source classification, source localization, and/or dereverberation by using the inferred characteristics of the room (e.g., physical enclosure), the inferred characteristics of any objects within the physical enclosure, the inferred characteristics of the environment of the physical enclosure, and/or inferred dynamic positions of audio sources within the physical enclosure.

Audio processing systems configured as discussed herein are adapted to produce improved audio signals with enhanced capture of desired audio signals and reduced noise. Various disclosed techniques further enable an audio signal processing system that is capable of audio source localization and/or audio source classification of audio signals using machine learning and other techniques described herein to determine audio localization events, telemetry data, and/or the audio classification events, which are then used to generate structured audio event data sets and ultimately, characteristics of the physical enclosure or objects or audio sources contained therein. Advantageously, by using such audio localization events and/or audio classification events to generate the structured audio event data sets, only information pertaining to relevant audio events are included within the structured audio event data sets, thereby reducing the overall size associated with such structured audio event data sets.

An audio processing system as discussed herein may employ a fewer number of computing resources when compared to traditional audio processing systems that are used for audio signal processing, and, in some embodiments, those spared computing resources may be used for other modalities such as video processing. Additionally or alternatively, such improved audio processing systems may be configured to deploy a smaller number of memory resources allocated to denoising, echo removal, source separating, source localizing, beamforming, dereverberation, or other processing of an audio signal sample. Furthermore, such improved audio processing systems may allow for improved processing speeds for denoising, echo removal, source separating, source localizing, beamforming, dereverberation or other operations and/or reduction of the number of computational resources associated with applying models to such tasks. These improvements enable the improved audio processing systems discussed herein to be deployed in microphones or other hardware/software configurations where processing and memory resources are limited, and/or where processing speed is important.

### Example System Architecture for Implementing Embodiments of the Present Disclosure

Audio signal processing systems disclosed herein are configured to capture a plurality of audio or other signals using one or more capture devices (e.g., audio capture devices, video capture devices, microphone arrays) and use those audio or other signals to infer characteristics of the physical enclosure or of objects or audio sources therein. To do so, various audio signal processing system embodiments disclosed herein apply digital signal processing (DSP) models or techniques (e.g., DSP, SRP-PHAT, MUSIC, or the like) and/or train and apply various machine learning models from a feature extraction framework and an audio event framework. The feature extraction framework may be configured to extract one or more sound localization events, telemetry data, sound classification events, and/or other events from the plurality of audio or other signals and generate one or more structured audio or other event datasets. The one or more structured audio or other event datasets are then provided to the various models of the audio event framework to determine one or more characteristics of the physical enclosure or objects or sources therein based at least in part on the structured audio or other event datasets.

It will be appreciated that, while embodiments herein are described with respect to audio capture devices and capture and processing of audio signals, one or more other capture devices (e.g., video capture devices, infrared capture devices, radar devices, light detecting and ranging (LiDAR) devices, sensor devices, or other capture devices for audio and/or video) may be employed without departing from the scope of the present disclosure.

The capture devices and/or methods of signal processing used for the capture of audio signals may then be adjusted based at least in part on the characteristics of the physical enclosure or objects or audio sources contained therein, such as by adjusting the beamforming parameters of the audio capture device, and/or various audio signal processing operations such as filtration, extraction, gain adjustments, and the like. In this way, techniques disclosed herein use inferred characteristics of the physical enclosure or objects or audio sources contained therein to improve audio signal processing. In particular, the inferred characteristics may describe characteristics pertaining to the physical enclosure, such as objects (e.g., three-dimensional shapes), noise regions, common speech regions and/or the centroids and/or boundaries thereof. The inferred characteristics may describe real-time or historical positions of objects or audio sources within the physical enclosure. As such, one or more adjustment signals may be generated to adjust various parameters of associated audio capture devices and/or audio signal processing parameters, which allow for adjustment of various operations, such as beamforming parameters of an audio capture device, and/or various audio signal processing operations such as filtration, extraction, gain adjustments, dereverberation, and the like.

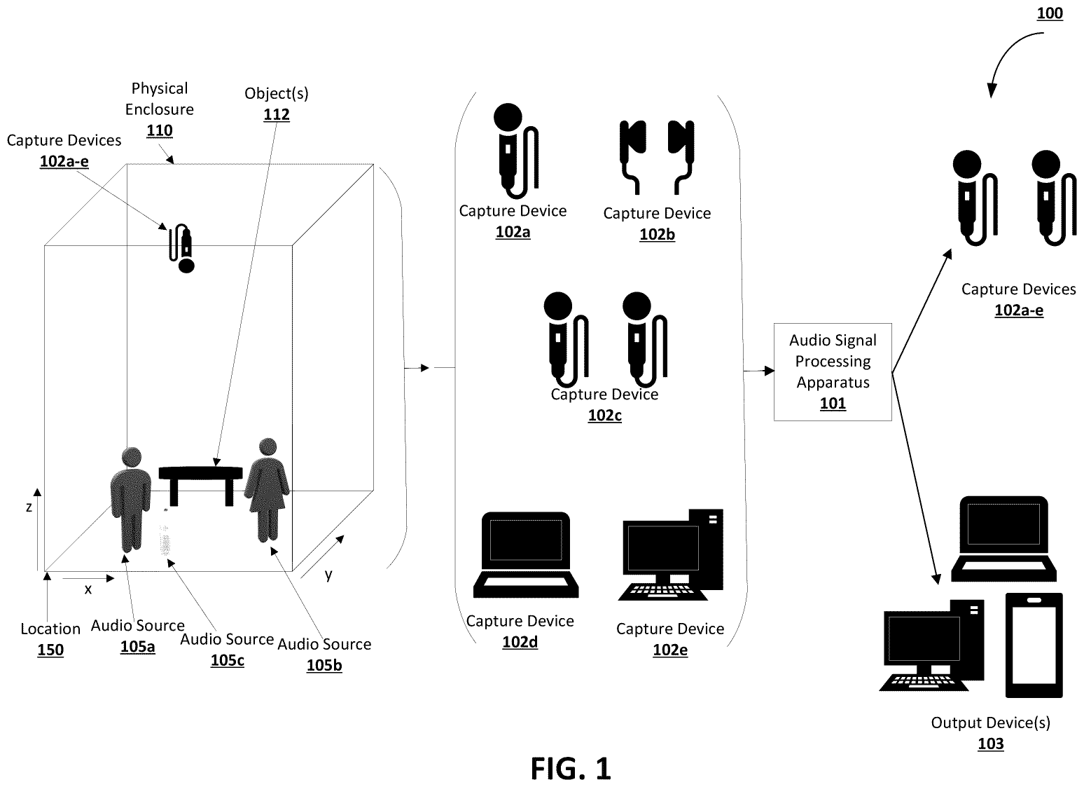

FIG. 1 is an example architecture 100 for performing various audio signal processing operations of the present disclosure. In the example embodiment of FIG. 1, an audio signal processing apparatus 101 receives audio signals from one or more of audio capture device 102a-e that are external to the audio signal processing apparatus 101. The audio signal processing apparatus 101 generates one or more adjustment signals which are configured to adjust parameters of the one or more capture devices (e.g., audio capture devices) 102a-e and/or the signal processing of the audio signals based at least in part on one or more determined characteristics. The audio signal processing apparatus may generate and provide a statistical summary data object to one or more output devices 103. It will be appreciated that at least one of the capture devices (e.g., audio capture devices) 102a-e or the output devices 103 may be a part of the audio signal processing apparatus 101.

Audio signals may emanate from one or more audio sources 105a, 105b, 105c and may be captured by audio capture devices 102a-e. An audio signal may describe audio data or an audio data stream or portion thereof that is capable of being transmitted, received, processed, and/or stored in accordance with embodiments of the present disclosure. An audio signal is captured by an audio capture device (e.g., a microphone array) and provided to an audio signal processing apparatus.

The audio sources 105 and/or audio capture devices 102a-e may be positioned within a physical enclosure 110. The audio capture devices 102a-e may be positioned at a known location (e.g., or a known or estimated location relative to another location) within the physical enclosure 110 and the audio signal processing apparatus 101 may be configured with the position of the audio capture devices 102a-e. The location of an audio capture device 102a-e may be indicated using a set of coordinates (e.g., x, y, z), which may specify a location relative to a distinct location, such as a location relative to a corner of a physical enclosure, the center of the physical enclosure, or another capture device. For example, location 150 of the physical enclosure 110 (e.g., a lower corner of the physical enclosure) may be the distinct location such that location 150 corresponds to a position (0,0,0). Audio capture device 102a-e may then correspond to a position of (25, 25, 50).

The one or more audio capture devices 102a-e may be configured to capture sound waves generated by the one or more audio sources 105a, 105b, 105c, such as speech, vocalizations, singing, music, and/or the like. The audio capture devices 102a-e may also capture sound waves generated by undesirable sounds, such as noise, reverberations off objects 112 within the physical enclosure 110, and/or the like.

The audio capture devices 102a-e may be any device configured to capture sound waves. In particular, the audio capture device 102a-e may include one or more microphones (including wireless or wired microphones), array microphones, in-ear monitors, headphones, laptops, desktops, mobile phones, tablets, notebooks, wireless audio receivers, audio conferencing microphones, and/or the like.

Any audio capture devices 102a-e may be configured to operate with one or more computer program applications, plug-ins, and/or the like. For example, a desktop device may be configured to execute a video conference computer program application. Wireless audio sensors typically include antennas for transmitting and receiving radio frequency (RF) signals which contain digital or analog signals, such as modulated audio signals, data signals, and/or control signals. A wireless audio receiver may be configured to receive RF signals from one or more wireless audio transmitters over one or more channels and corresponding frequencies. For example, a wireless audio receiver may have a single receiver channel so that the receiver is able to wirelessly communicate with one wireless audio transmitter at a corresponding frequency.

As another example, a wireless audio receiver may have multiple receiver channels, where each channel can wirelessly communicate with a corresponding wireless audio transmitter at a respective frequency. The output devices 103 may include one or more devices configured to transmit or broadcast audio signals. The output devices 103 may be capable of performing various operations, such as beam steering, to direct audio signals in controlled directions. Examples of output devices 103 include wireless audio transmitters that are configured to transmit a signal, carrier wave, or the like to one or more audio receivers.

Once captured, the plurality of audio signals are provided to the audio signal processing apparatus 101. The audio signal processing apparatus 101 may be configured to provide a plurality of audio signals to a feature extraction framework that is configured to process the plurality of audio signals captured by the one or more audio capture devices, extract one or more sound localization events and/or one or more sound classification events, generate one or more structured audio event data sets, and provide the one or more audio event data sets to an audio event framework. In turn, the audio event framework may be configured to process the one or more audio event data sets and determine one or more characteristics of a physical enclosure, objects within the physical enclosure, an environment of the physical enclosure, and/or audio sources within the physical enclosure associated with the audio capture devices. The characteristics may be determined in real-time and monitored over time using historically inferred characteristics. The audio event framework may be configured to generate one or more adjustment signals configured to adjust various parameters of the one or more audio capture devices and/or audio signal processing parameters. Additionally or alternatively, the audio event framework may be configured to generate a statistical summary data object and provide the statistical summary data object to one or more output devices.

The output devices 103 may be configured to receive one or more adjustment signals from the audio signal processing apparatus 101 and adjust the one or more operating parameters, such as beam direction, based at least in part on the one or more adjustment signals. The one or more adjustment signals may be determined based at least in part on the one or more determined characteristics of the physical enclosure 110. For example, a microphone array (e.g., audio capture device 102a-e and/or output device 103) may receive the one or more adjustment signals which instruct the microphone array to perform beam steering in the direction of a common speech area. Parameters may include limits or regions where beams may be directed to capture audio, or regions from which beams should be steered away (as they may be tagged as noisy, or containing loudspeakers (e.g., a source of far-end audio). Parameters may also include, for example, a steerable beam-null (an “anti”-beam) that may be directed toward a location of a loudspeaker to enhance AEC performance. Other parameters may include AEC LMS coefficients, AEC NLP levels, EQ parameters, beam widths, channel gains, and the like. As such, the microphone array is directed to better capture audio signals which likely emanate from desired audio signals while potentially reducing the capture of undesirable audio signals (e.g., noise). By way of further example, one or more adjustment signals can be used to inform other modality sensors, such as video directivity, video tracking, video fencing, and gaming and virtual reality constructs.

Audio signal processing systems as discussed herein may be implemented as a microphone, a digital signal processing (DSP) apparatus, and/or as software that is configured for execution on a laptop, PC, or other device. Audio signal processing systems can further be incorporated into software that is configured for automatically processing speech from one or more microphones in a conferencing system (e.g., an audio conferencing system, a video conferencing system, and the like). An audio signal processing system can be integrated within an inbound audio chain from remote participants in a conferencing system. The improved audio signal processing system can be integrated within an outbound audio chain from local participants in a conferencing system.

### Example Data Flows of Embodiments of the Present Disclosure

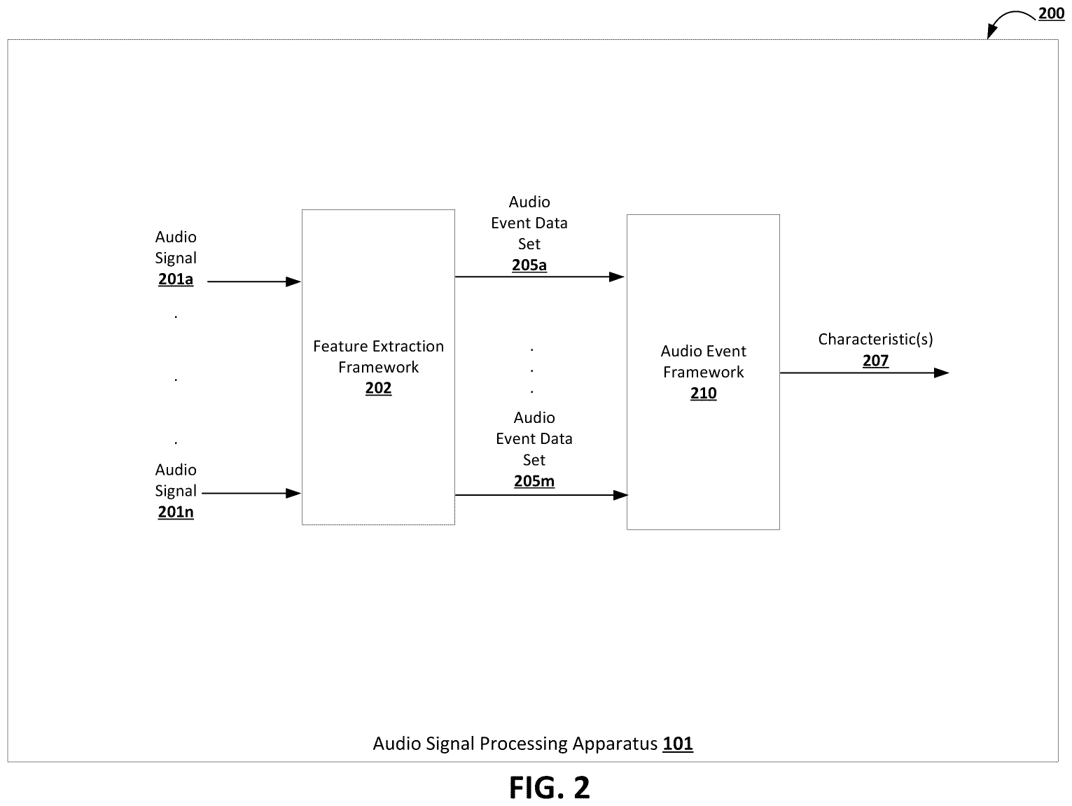

FIG. 2 is an example audio signal processing apparatus 101 configured to apply a process 200 employing a feature extraction framework and an audio event framework in accordance with one embodiment of the present disclosure. The process 200 begins when the audio signal processing apparatus 101 receives n audio signals 201a-201n from n audio capture devices (not depicted). The depicted feature extraction framework 202 is configured to process the n audio signals 201a-201n to generate m structured audio event data sets.

The feature extraction framework 202 may describe parameters, hyper-parameters, and/or defined operations of a set of machine learning models or other models such as DSP approaches that are collectively configured to extract at least one or more sound localization events and/or sound classification events from a plurality of audio signals and generate one or more structured audio event data sets based at least in part on the one or more sound localization events and/or sound classification events. The feature extraction framework 202 may include a set of machine learning models or other models or approaches (e.g., DSP techniques) that are collectively configured to extract at least one or more sound localization events and/or sound classification events from audio signals 201a-201n and generate m structured audio event data sets based at least in part on the one or more sound localization events and/or sound classification events. In some embodiments, the feature extraction framework may comprise one or more audio source localization machine learning models, one or more audio source classification machine learning models, one or more feature aggregation machine learning models, and/or DSP-based equivalents of the same.

Continuing with the example depicted in FIG. 2, the process 200 continues when the feature extraction framework 202 provides the m structured audio event data sets 205a-205m to an audio event framework 210. The audio event framework 210 may be configured to describe parameters, hyper-parameters, and/or defined operations of a set of machine learning models that are collectively configured to process the one or more structured audio event data sets and determine one or more characteristics of a physical enclosure based at least in part on the one or more structured audio event data sets. The audio event framework 210 may, alternatively, be configured to process the one or more structured audio event data sets and determine one or more characteristics of the physical enclosure or objects or audio sources therein using DSP approaches.

The audio event framework 210 may be configured to receive the m audio event data sets and determine one or more characteristics 207 of the physical enclosure, or of objects or audio sources therein. The audio event framework 210 may further be configured to generate one or more adjustment signals based at least in part on the one or more determined characteristics 207. The one or more adjustment signals may be provided to one or more output devices 103.

The audio event framework 210 may further be configured to generate a statistical summary data object and provide the statistical summary data object to one or more output devices 103.

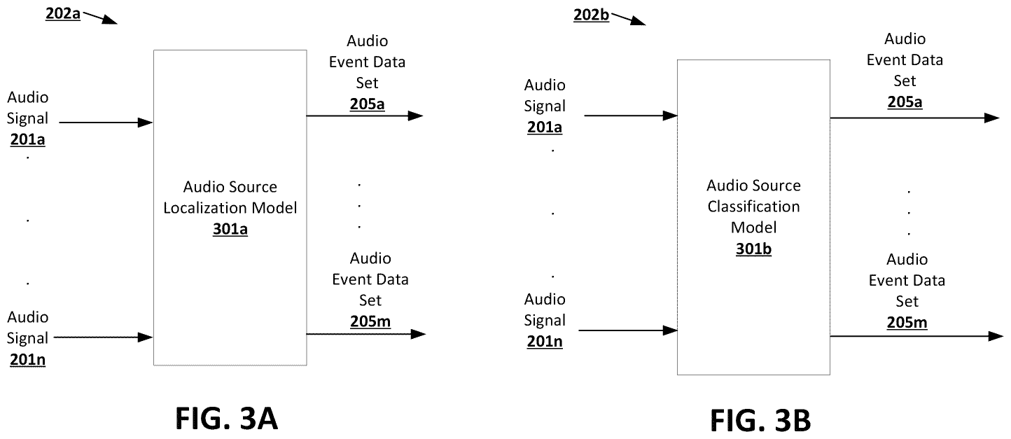

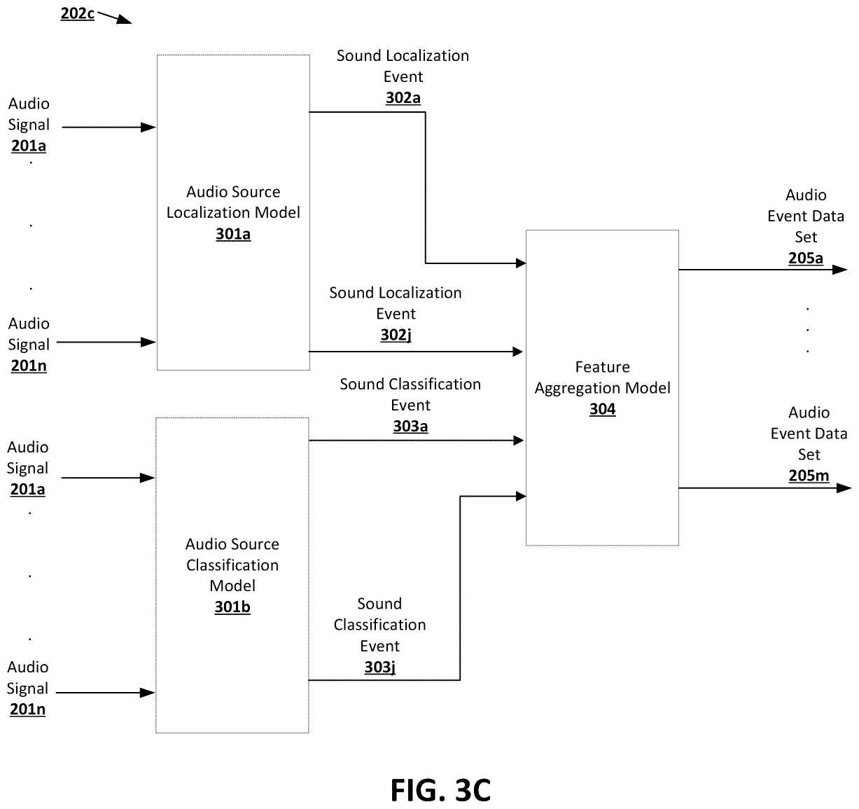

Various operational examples, 202a, 202b, and 202c, of a feature extraction framework 202 are depicted in FIGS. 3A-3C.

As depicted in FIG. 3A, an example feature extraction framework 202a may comprise an audio source localization model 301a. The audio source localization model 301a may be configured to describe parameters, hyper-parameters, and/or stored operations of a model that is configured to process a plurality audio signals extract one or more sound localization events and generate one or more structured audio event data sets based at least in part on the one or more sound localization events. The audio source localization model may include a convolutional neural network model that is configured to process a plurality of audio signals to determine one or more sound localization events. The audio source localization model may be configured to process each audio signal of the plurality of audio signals in a manner that leads to a predicted inference which describes a location from which an audio signal was emitted relative to a distinct location or relative to a location of the capture device that captured the audio signal.

As described above, the audio source localization model 301a may be configured to receive the n audio signals 201a-n and generate m structured audio event data sets 205a-m. In particular, the audio source localization machine learning model 301a may be configured to process the n audio signals, extract one or more sound localization events, and generate m structured audio event data sets based at least in part on the one or more sound localization events. Although only one audio source localization model is depicted, any number of audio source localization models may be contemplated.

The audio source localization model may be configured to process each audio signal of the m audio signals in a manner that leads to a predicted inference which describes a location from which an audio signal was emitted relative to a distinct location. The audio source localization model may generate one or more sound localization events, which may each describe the location of the event inferred by the audio source localization model 301a. Each sound localization event may comprise one or more vectors, which may describe the location of the event inferred by the audio source localization model.

A sound localization event may be configured to describe an inferred location of a sound event. A sound event may be any event captured within an audio signal which is associated with decibel levels which satisfy one or more thresholds. A sound localization event comprise one or more vectors, which describe the location of a sound event (e.g., x, y, z coordinates, spherical coordinates (azimuth, elevation, radius), or the like) inferred by the audio source localization model. The location of the event may be relative to a distinct location, such as a location relative to a corner of a physical enclosure, an audio capture device, the center of the physical enclosure, and the like.

For example, referring back to FIG. 1, if audio source 105a produced speech, the audio source localization model may determine a sound localization event based on the one or more audio signals which captured the verbalization by audio source 105a. The sound localization event may comprise a tuple of values that describe a point associated with a location of audio source 105a within the physical enclosure. For example, the sound localization event may comprise a tuple having the values (15, 15, 10). This tuple may indicate a location of the sound event with respect to point 150 of the physical enclosure. The sound localization event may further comprise a timestamp, such as a sound event timestamp of 2022-01-30, 9:00:00, indicative that the audio signal was captured on Jan. 30, 2022 at 9 am. It will be appreciated that a series of sound event timestamps may be associated with an audio source (e.g., 105a), where the series includes a long train of events based on having captured sound localization events many times (e.g., −100,000 times) per minute.

The resulting one or more structured audio event data sets generated by the audio source localization model may include each sound localization event which occurred within a time window. For example, a time window may be a time period of one week such that any sound localization events that were determined within the one week time window are included in the one or more structured audio event data sets. Each structured audio event data sets may comprise a plurality of structured audio event data points, which may correspond to a particular sound localization event. Each structured audio event data set may be formatted as a vector and/or a matrix and each audio event data point may be configured to describe a sound localization event. It will be appreciated that capturing sound localization events for a time window of a few minutes may result in gigabytes of data that embodiments herein are configured to efficiently and accurately process.

Each structured audio event data set may be associated with an audio event type. For example, audio event types may include a volumetric (or spatial) audio event type or a temporal audio event type. Each audio event type may correspond to an audio event domain, which may be characterized by the plurality of candidate range values for the audio event type. For example, the candidate range values may be determined by the maximum and/or minimum location values as determined from the one or more sound localization events.

For volumetric audio event types, the candidate range values may correspond to the physical enclosure dimensions. For example, a physical enclosure may be characterized by a width, length, and height of 50, 50, and 50 meters, respectively. As such, the candidate range values for the volumetric audio event type may range from 0-50 in each direction. The plurality of candidate range values may be provided by one or more output devices 103 to the audio signal processing apparatus 10. Alternatively, the audio signal processing apparatus may be configured to determine the candidate range values by generating and transmitting known audio signals to output devices such as speakers, which may be configured to emit the audio signals. The audio signal processing apparatus may then process the received audio signals to determine physical enclosure dimensions.

Furthermore, an associated bin granularity value may determine a number or count of candidate range values. A bin granularity value may determine the sensitivity of the location of the captured audio localization event. By way of continuing example, a bin granularity value of 50 would result in 50 bins in each direction, for a total number of 125,000 bins. Each bin may be associated with a particular value range. For example, a bin may be associated with an x coordinate range of 10-11, a y coordinate range of 20-21, and a z coordinate range of 25-26. As such, a sound localization event which corresponds to coordinates of (11, 21, 25) would correspond to this particular bin. The audio source localization model may be configured to map the one or more sound localization events of a particular time window to the one or more candidate range values to generate a structured audio event data set.

Similarly, for temporal audio event types, the candidate range values may correspond to the time window. For example, a time window of one week may be associated with candidate range values of 0-168 hours. an associated bin granularity value may determine the number of candidate range values. A temporal audio event type may also be associated with a bin granularity value, which may determine the temporal sensitivity of the captured audio localization event. For example, a bin granularity value of 24 hours would result in 7 bins while a bin granularity value of 2 hours would result in 84 bins. Each bin may be associated with a particular value range. For example, a bin may be associated with a time of 158-160 hours. As such, a sound localization event which corresponds to an event time stamp of 159 hours would correspond to this particular bin. The audio source localization model may be configured to map the one or more sound localization events of a particular time window to the one or more candidate range values to generate a structured audio event data set.

In some embodiments, the audio source localization model can provide Vector Symbolic Architecture (VSA) encodings for the location and/or classification for the audio sources. A number of location and/or classification predictions (e.g., a number of VSA encodings) can be based on a number of audio sources located in the audio environment or physical enclosure. In certain embodiments, the classification for the audio sources can include an audio class (e.g., a first type of audio source or a second type of audio source), a speech class (e.g., a first type of user class or a second type of user class), an equalization class (e.g., a low frequency class, a middle frequency class, a high frequency class, etc.), and/or another type of classification for the audio sources. In some embodiments, the audio source localization model can provide location as well as classification, thereby eliminating the need for the audio source classification model within the feature extraction framework.

As depicted in FIG. 3B, an example feature extraction framework 202b may include an audio source classification model 301b. The audio source classification model 301b may be configured to describe parameters, hyper-parameters, and/or stored operations of a model that is configured to process a plurality audio signals to generate one or more sound classification events. The audio source classification model may comprise a convolutional neural network that is configured to process a plurality of audio signals to generate one or more sound classification events. In some examples, the audio source classification model may include machine learning model comprising a set of classification layers (e.g., a set of fully connected classification layers) that are configured to process a convolutional representation of an audio source component in order to generate the one or more sound classification events. In some examples, the audio source classification model may employ traditional DSP processing or techniques, spectral-variance, cepstrum evaluation, and/or the like, along with or instead of machine learning techniques. The audio source classification model may be configured to process each audio signal of the plurality of audio signals in a manner that leads to the classification of the sound event into one or more sounds classifications of a plurality of candidate sound classifications, such as a voice activity detection (VAD) classification, a noise classification, a reverberation classification, and/or the like.

As depicted in FIG. 3B, the audio source classification model 301b may be configured to receive the n audio signals 201a-n and generate m structured audio event data sets 205a-m. In particular, the audio source classification model 301b may be configured to process the n audio signals, extract one or more sound classification events, and generate m structured audio event data sets based at least in part on the one or more sound classification events. A sound classification event may be configured to describe a sound classification of a sound event. event. A sound event may be any event captured within an audio signal which is associated with decibel levels which satisfy one or more thresholds. The sound classification event may comprise one or more vectors, which describe the classification of a sound event (e.g., VAD classification, noise classification, reverberation classification, and the like) as determined by the audio source classification model. The sound classification event may further include the sound event timestamp, which may be indicative of the time at which the sound event occurred and/or was captured by an audio capture device. By way of example, if an audio source 105a produced speech, the audio source classification model may determine a sound classification event based on the one or more audio signals which captured the verbalization by audio source 105a. The sound classification event may then describe the classification of the sound event as a VAD classification. The sound classification event may further describe a sound event timestamp of 2022-01-30, 9:00:00, indicative that the audio signal was captured on Jan. 30, 2022 at 9 am.

The resulting one or more structured audio event data sets generated by the audio sound classification model may include each sound classification event which occurred within a time window. For example, a time window may be a time period of one week such that any sound classification events that were determined within the one week time window are included in the one or more structured audio event data sets. Each structured audio event data sets may comprise a plurality of structured audio event data points, which may correspond to a particular sound classification event. Each structured audio event data set may be formatted as a vector and/or a matrix and each audio event data point may be configured to describe the sound event with respect to a sound classification event. The structured audio event data set may comprise a plurality of sound classification events which occurred over a time window.

As described above with respect to the audio source localization model 301a, each structured audio event data set is associated with an audio event type. For the audio source classification model, the audio event types may include a temporal audio event type or a spatial/volumetric audio event type, which may correspond to an audio event domain characterized by the plurality of candidate range values for the audio event type. The audio source localization model may be configured to map the one or more sound classification events of a particular time window to the one or more candidate range values to generate a structured audio event data set.

As depicted in FIG. 3C, an example feature extraction framework 202c may comprise an audio source localization model 301a, an audio source classification model 301b, and a feature aggregation model 304. The feature aggregation model 304 may be configured to describe parameters, hyper-parameters, and/or stored operations of a machine learning model that is configured to process one or more sound localization events as received from one or more audio source localization models 301a and one or more sound classification events as received from one or more audio classification models 301b to generate the one or more structured audio event data sets.

Here, the feature extraction framework 202c may be configured to generate j sound localization events 302a-j using the audio source localization model 301a and j sound classification events 303a-j using the audio source classification model 301b. The feature aggregation model 304 may be configured to receive the j sound localization events 302a-j and j sound classification events 303a-j to generate the m structured audio event data sets 205a-m.

The feature aggregation model 304 may be configured to identify corresponding audio events within the one or more sound localization events and one or more sound classification events and associate sound localization events with corresponding sound classification events. For example, the feature aggregation model 304 may be configured to associated sound localization events and sound classification events based at least in part on their associated event time stamp. In an instance the event time stamp for a sound localization event is within a predefined time threshold of an event time stamp for a sound classification event, the sound localization event and sound classification event are determined to be associated with one another.

The feature aggregation model may further be configured to generate one or more structured audio event data sets based at least in part on the one or more sound localization events and sound classification events. The resulting one or more structured audio event data sets generated by the feature aggregation model may include each sound localization event and corresponding sound classification event which occurred within a time window. Each structured audio event data sets may comprise a plurality of structured audio event data points, which may correspond to a particular sound localization event and a corresponding sound classification event. Each structured audio event data set may be formatted as a vector and/or a matrix and each audio event data point may be configured to describe a sound localization event and a corresponding sound classification event.

As described above in FIGS. 3A-3B, each structured audio event data set is associated with an audio event type. For example, audio event types may include a volumetric audio event type or a temporal audio event type. The feature aggregation model may be configured to map the one or more sound localization events and/or sound classification events of a particular time window to the one or more candidate range values to generate a structured audio event data set. The use of a feature aggregation model advantageously allows for the association of sound classification events with sound localization events such that sound classification events may also be mapped to the one or more candidate range values for a volumetric audio event type to generate a structured audio event data set. As such, the classification of various events may not only be determined temporally, but also spatially.

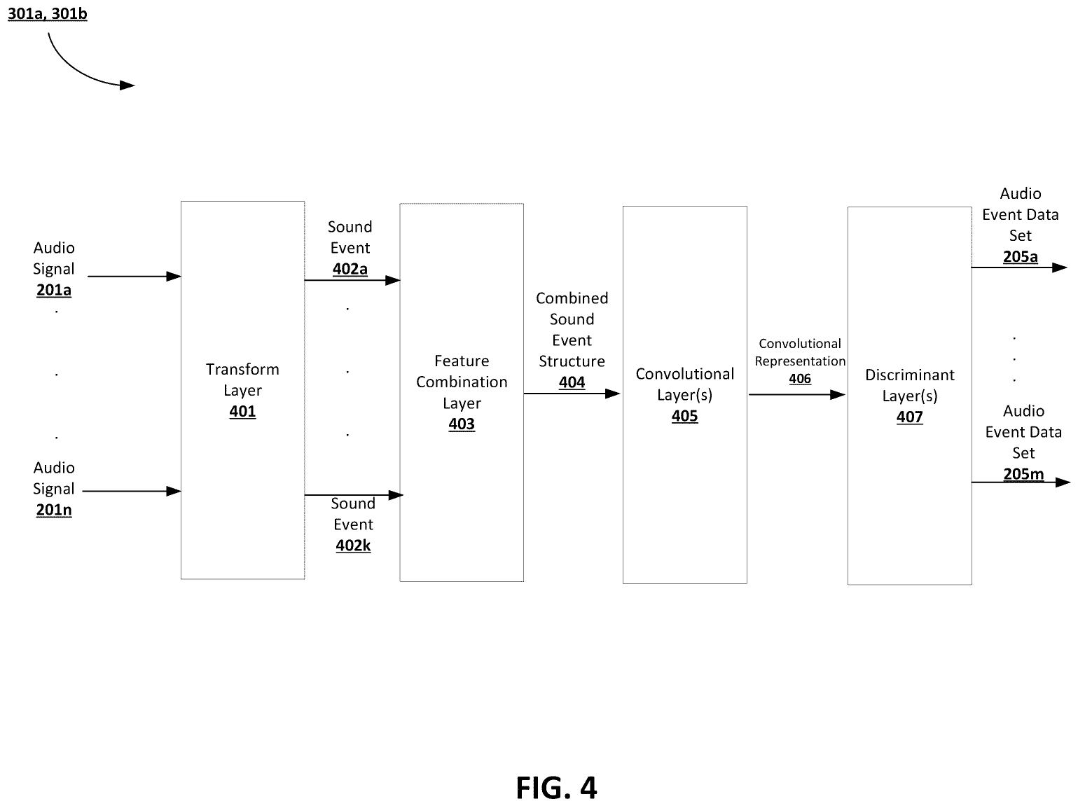

An operational example of either an audio source localization model 301a and/or an audio source classification model 301b is depicted in FIG. 4. As depicted in FIG. 4, the audio source localization model 301a and/or an audio source classification model 301b may comprise a transform layer 401 that is configured to perform one or more feature extraction operations the n audio signals 201a-201n to generate k sound events 402a-402k (e.g., sound localization events and/or sound classification events) for each of the n audio signals 201a-201n. Examples of feature extraction operations that may be performed on an audio signal include generating a mel-frequency cepstrum (MFC) representation of the audio signal, generating a magnitude-only spectrum of the audio signal, generating a cochleagram of the audio signal, and generating a cochlea neural transformation of the audio signal.

As further depicted in FIG. 4, the audio source localization model 301a and/or an audio source classification model 301b further comprises a feature combination layer 403 that is configured to combine the k sound events 402a-402k as identified from each audio signal 201a-201n to generate a combined sound event structure 404. As such, in the event multiple audio capture devices capture the same sound event, the sound event is only identified by the audio signal processing apparatus 101 once.

As further depicted in FIG. 4, the audio source localization model 301a and/or an audio source classification model 301b may further comprise a set of convolutional layers 405 that are configured to process the combined sound event structure 404 to generate a convolutional representation 406 of the combined sound event structure 404. The convolutional operations performed by the set of convolutional layers 405 may employ kernels that map portions of the combined sound event structure 404 to values spanning a range of time (or frequency and time) and a range of space (audio capture devices).

The convolutional operations may be applied to a degree that covers the maximum time difference between received signals across the largest spatial extent of the audio capture devices (e.g., the time it takes a signal). The set of convolutional layers 405 may perform convolutional operations of a convolutional U-Net. Alternatively, the set of convolutional layers 405 perform convolutional operations of a fully-convolutional time-domain audio separation network (Conv-TasNet).

As further depicted in FIG. 4, the audio source localization model 301a and/or an audio source classification machine learning model 301b further comprise a set of discriminant layers 407 that are configured to process the convolutional representation 406 to generate the m structured audio event datasets. The set of discriminant layers 407 may perform operations of a set of fully-connected neural network machine learning layers. The set of discriminant layers 407 may perform operations of a machine learning model employing a vector symbolic architecture.

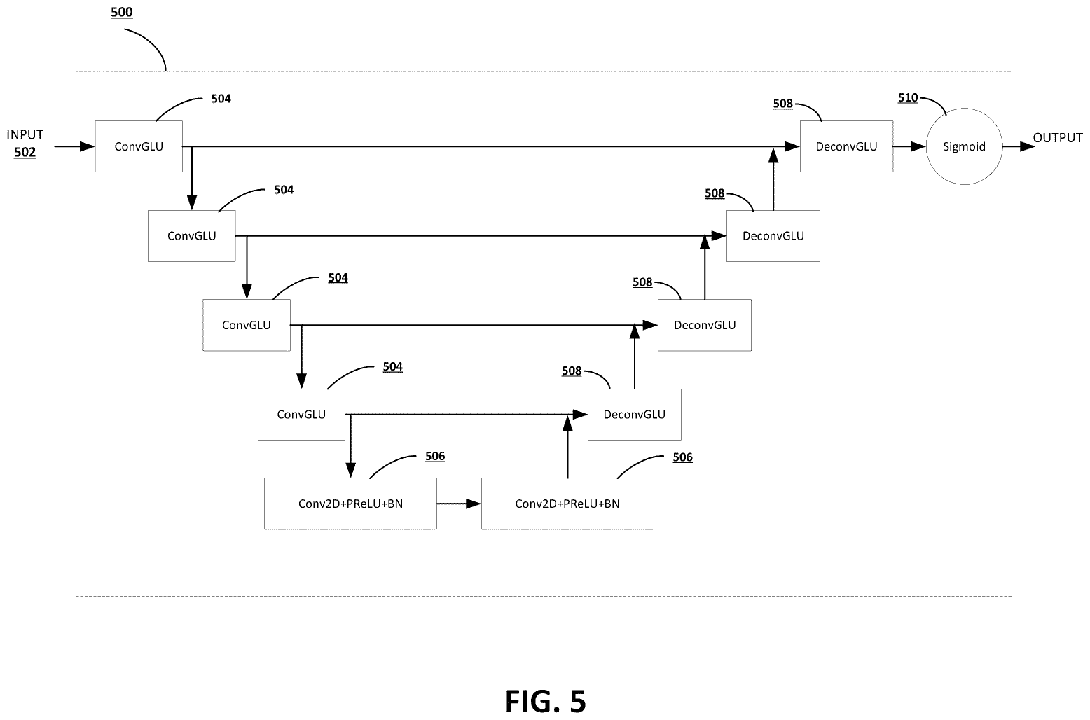

FIG. 5 illustrates an audio source localization model 301a and/or an audio source classification model 301b according to one or more embodiments of the present disclosure. The audio source localization model 301a and/or an audio source classification model 301b can be a fully convolutional deep neural network (DNN). In an aspect, the audio source localization model 301a and/or an audio source classification machine learning model 301b can include a set of convolutional layers configured in a U-Net architecture 500. In another aspect, the audio source localization model 301a and/or an audio source classification model 301b can include an encoder/decoder network structure with skip connections. Input 502 may be provided to the audio source localization model 301a and/or an audio source classification model 301b. The input 502 may correspond to the set of n audio signals 201a-201n from a set of n audio capture devices, for example. The audio source localization model 301a and/or an audio source classification model 301b may include a set of downsampling layers 504 and a set of upsampling layers 508 associated with deconvolutional gated linear units.

An encoder branch of the audio source localization model 301a and/or an audio source classification model 301b is formed by the set of downsampling layers 504 that downsample the input 502 in a frequency axis by a factor of two while keeping a time axis at a same resolution to reduce latency during real-time implementation of the audio source localization model 301a and/or an audio source classification model 301b. A decoder branch of audio source localization model 301a and/or an audio source classification model 301b may be formed by the set of upsampling layers 508 that upsample the input 502 back to an original size of the input 502. Each gated linear unit can include a convolutional layer gated by another parallel convolutional layer with a sigmoid layer configured as an activation function. Additionally or alternatively, batch normalization and/or parametric rectified linear unit activation can be performed after the gating.

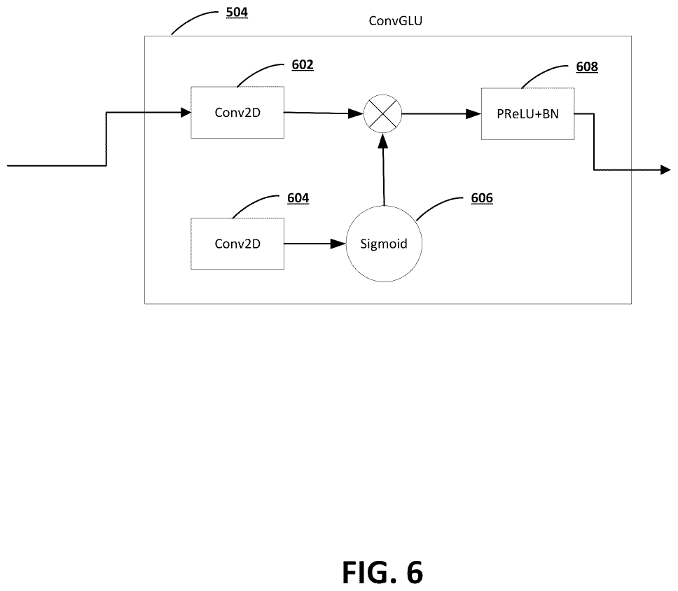

FIG. 6 illustrates a downsampling layer 504 according to one or more embodiments of the present disclosure. The downsampling layer 504 may include a convolutional layer 602, a convolutional layer 604 and a sigmoid layer 606. Additionally, the downsampling layer 504 may include batch normalization and parametric rectified linear unit layer 608.

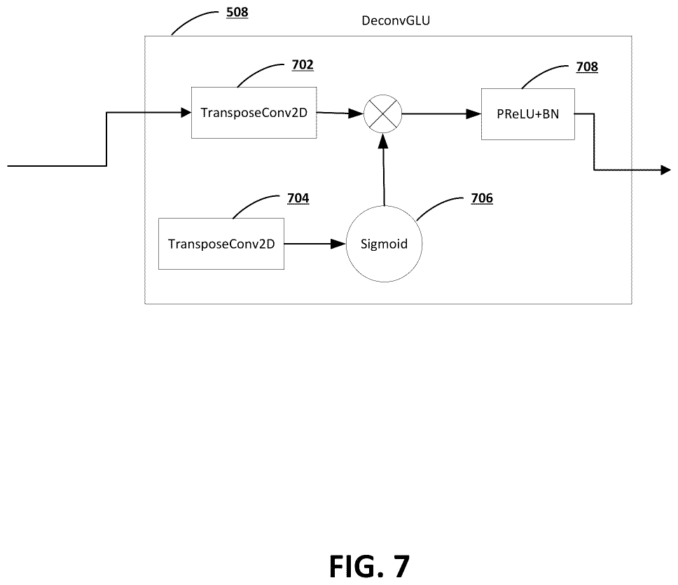

FIG. 7 illustrates an upsampling layer 508 according to one or more embodiments of the present disclosure. The upsampling layer 508 includes a convolutional transpose layer 702, a convolutional transpose layer 704 and a sigmoid layer 706. Additionally, the upsampling layer 508 includes batch normalization and parametric rectified linear unit layer 708. Referring back to FIG. 6, intermediate output features from the set of downsampling layers 504 can be concatenated with the input features of the set of upsampling layers 508 to form, for example, skip connections.

A bottleneck portion of the audio source localization model 301a and/or an audio source classification model 301b between the set of downsampling layers 504 and the set of upsampling layers 508 can include a set of convolutional layers 506. A first convolutional layer from the set of convolutional layers 506 can include first downsampling, first batch normalization and/or first parametric rectified linear unit activation. Furthermore, a second convolutional layer from the set of convolutional layers 506 can include second downsampling, second batch normalization and/or second parametric rectified linear unit activation. A sigmoid layer 510 can be added to the final output audio source localization model 301a and/or an audio source classification model 301b to produce the output that includes structured audio event datasets 205a-205m.

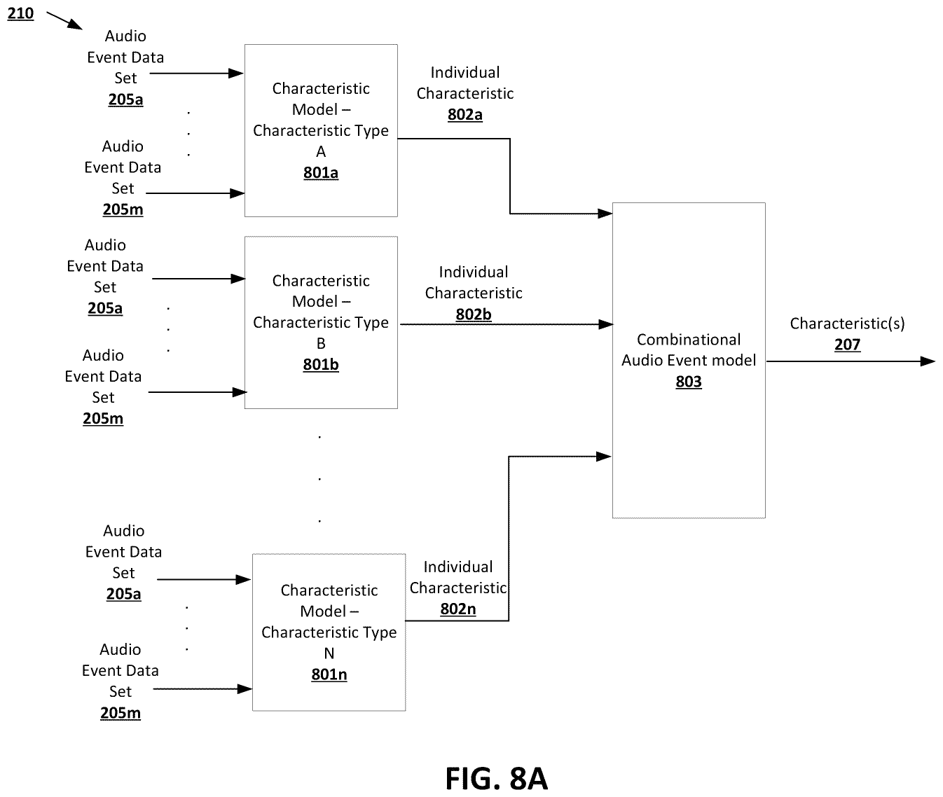

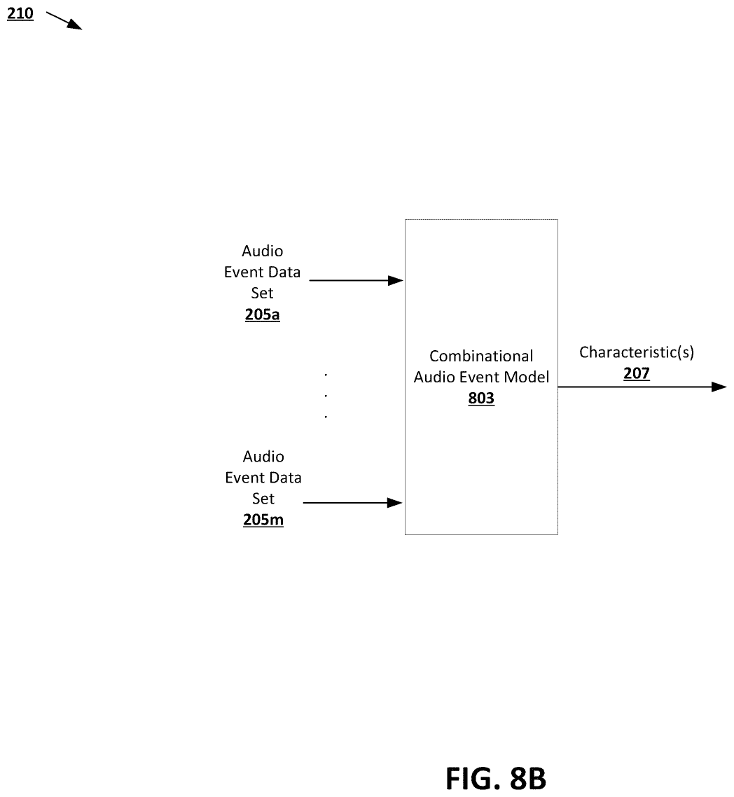

FIG. 8A depicts an operational example of an audio event framework that comprises n characteristic prediction models 801a-n and a combinational audio event model 803. Each characteristic prediction model 801a-n may be configured to describe parameters, hyper-parameters, and/or stored operations of a model that is configured to process one or more structured audio event data sets to generate one or more individual characteristic of a physical enclosure. Each characteristic prediction model 801a-n may comprise a convolutional neural network that is configured to process the one or more structured audio event data sets and determine one or more characteristics of a physical enclosure where the one or more audio signals were captured. The characteristic prediction model 801 a-n may be configured to process each structured audio event data set in a manner that leads to a predicted inference which describes a characteristic of the physical enclosure.

Each characteristic prediction model 801a-n may be configured to process the m structured audio event data sets to generate individual characteristics 802a-c for the physical enclosure. Each characteristic prediction model 801a-n may be trained to infer a particular characteristic type. A characteristic type may include prediction of objects (e.g., three-dimensional shapes), noise regions, common speech regions and/or the centroids and/or boundaries thereof. Each individual characteristic may be formatted as a vector.

In particular, the characteristic prediction model may be configured to process each structured audio event data set 305a-m in a manner that leads to a predicted inference which describes a characteristic of the physical enclosure. The inferred characteristic may also be determined with respect to a particular location within the physical enclosure. Each characteristic prediction model may be trained or configured to infer a particular characteristic type. A characteristic type may include prediction of objects (e.g., three-dimensional shapes), noise regions, common speech regions and/or the centroids and/or boundaries thereof. For example, characteristic prediction model 801a may be configured to generate an individual characteristic for the physical enclosure that infers the voice activity regions of the physical enclosure (e.g., characteristic type A) while characteristic prediction model 801b may be configured to generate an individual characteristic for the physical enclosure that infers the noise regions of the physical enclosure (e.g., characteristic type B).

As further depicted in FIG. 8A, each characteristic prediction model 801a-n may be configured to provide the individual characteristics 802a-c to a combinational audio event model 803. The combinational audio event model 803 may be configured to describe parameters, hyper-parameters, and/or stored operations of a model that is configured to process one or more individual characteristics from one or more characteristic prediction model to determine one or more characteristics of the physical enclosure. The combinational audio event model may be configured to combine the one or more individual characteristics to generate one or more characteristic predictions for the physical enclosure, which may include characteristics of various characteristic types.

The combinational audio event model 803 may process the n individual characteristics from n characteristic prediction models 801a-n to determine one or more characteristics of the physical enclosure (or objects or audio sources therein). The combinational audio event model may be configured to aggregate the one or more individual characteristics to generate one or more characteristic predictions for the physical enclosure, which may include characteristics of various characteristic types. Each characteristic may be formatted as a vector.

The characteristic prediction models and/or combination audio event model, in some examples, train and apply machine learning models to accomplish the aforementioned processes. In other examples, the characteristic prediction models and/or combination audio event model leverage other techniques. For example, to determine the geometric range that sounds span over time in x, y, z (e.g., the spatial volume where speech is found in a room) the max and min bins that have counts in them in each dimension the structured data set may be determined or utilized.

Alternatively, FIG. 8B depicts an operational example of an audio event framework that comprises a combinational audio event model 803. Here, the combinational audio event model 803 may be configured to process each structured audio event data set 205a-m in a manner that leads to a predicted inference which describes a characteristic of the physical enclosure without the characteristic prediction models 801 a-n. Similarly, as described with respect to FIG. 8A, the inferred characteristic may also be determined with respect to a particular location within the physical enclosure. The combinational audio event model may be trained to infer any characteristic type. A characteristic type may include prediction of objects (e.g., three-dimensional shapes), noise regions, common speech regions and/or the centroids and/or boundaries thereof. For example, combinational audio event model 803 may be configured to generate one or more characteristic for the physical enclosure that infers the voice activity regions of the physical enclosure (e.g., characteristic type A) and a characteristic for the physical enclosure that infers the noise regions of the physical enclosure (e.g., characteristic type B).

The combinational audio event model 803 may generate one or more adjustment signals and provide the adjustment signals to one or more output devices. The one or more adjustment signals may be configured to adjust various parameters of the one or more audio capture devices and/or audio signal processing parameters. As such, the audio capture devices and/or the method of signal processing used for the capture audio signals may then be adjusted based at least in part on the characteristics of the physical enclosure, such as by adjusting the beamforming parameters of the audio capture device, and/or various audio signal processing operations such as filtration, extraction, gain adjustments, and the like.

The combinational audio event model 803 may generate a statistical summary data object and provide the statistical summary data object to one or more output devices. The statistical summary data object may be configured to describe the one or more determined characteristics for the physical enclosure, one or more sound localization event statistics, one or more sound classification event statistics, one or more sound event statistics, one or more physical enclosure characteristic predicted representations, and/or the like.

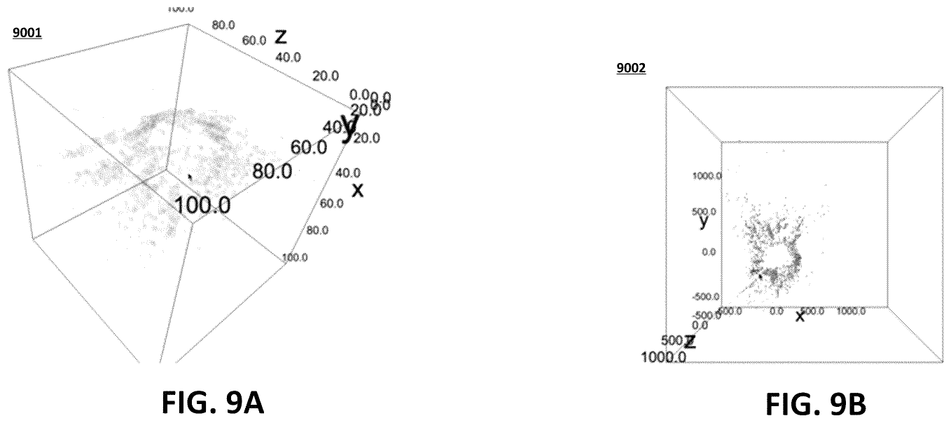

Operational examples of structured audio event data sets are depicted in FIGS. 9A-B. FIG. 9A depicts a volumetric audio event type structured audio event data set representation 9001. Each point of the structured audio event data set representation corresponds to a particular sound localization event within a time window. Here, the corresponding audio event data set may have been generated using an audio source localization model 301.

FIG. 9B depicts a volumetric audio event type structured audio event data set representation 9002. Here, each point of the structured audio event data set representation corresponds to a particular sound localization event within a time window and is further classified according to the sound classification event. In particular, the green structured audio event data points correspond to a WAD′ sound classification event while the black structured audio event data points correspond to a ‘noise’ sound classification event. Here, the corresponding audio event data set may have been generated using a feature aggregation model 304.

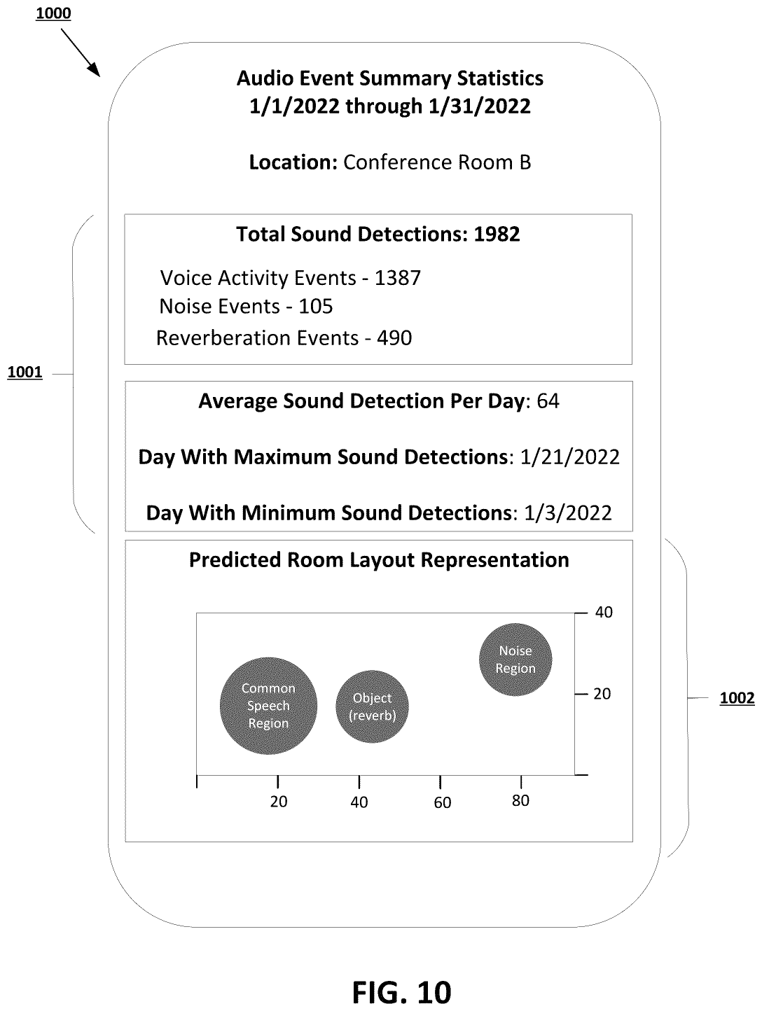

FIG. 10 depicts an operational example of a statistical summary data object 1000. The statistical summary data object 1000 describes statistical data 1001 which includes one or more sound localization event statistics, one or more sound classification event statistics, one or more sound event statistics, and the like. One or more end users associated with the output device 103 may interact with the statistical summary data object (e.g., read, view, extract, upload, and the like) in various ways.

The statistical data may describe an overall count of the number of events (e.g., sound events, sound classification events, and the like), event count averages, event maximums and/or minimums, and/or the like. The statistical summary data object 1000 may further describe one or more physical enclosure characteristic predicted representations 1002. The physical enclosure characteristic predicted representation 1002 may depict one or more objects inferred to be within the physical enclosure, one or more noise regions, common speech regions and/or the centroids and/or boundaries thereof. The statistical summary data object 1000 may further include one or more structured audio event data set representations, such as those depicted in FIGS. 9A-B.

While FIG. 10 may depict a renderable interface presenting a statistical summary data object, embodiments herein are configured to expose statistical data captured and/or generated according to the present disclosure via application programming interfaces (APIs). The APIs may be local to the audio processing system or apparatus or may be associated with separate computing devices that the audio processing system provides the statistical data to through the APIs.

It further will be appreciated that, while the statistical data depicted in FIG. may appear manageable, a scale of events captured and processed by embodiments herein are much larger. For example, when attempting to generate room images (a programmatic representation of a physical enclosure) from telemetry events or data as described herein, ˜100,000 events per minute or even second may be captured and processed. To provide 2D and 3D maps or a room in terms of sound classes (e.g., where sound comes from, where we predict objects may be (e.g. table, chairs)) and general summary statistics (e.g., speech occurs this many minutes a day in this pattern, ratio of speech vs. non-speech, etc.), the volume of data is significant. Embodiments herein advantageously infer relevant characteristics based on telemetry data and various models in order to reduce required processing resources and time.

### Example Audio Signal Processing Apparatus

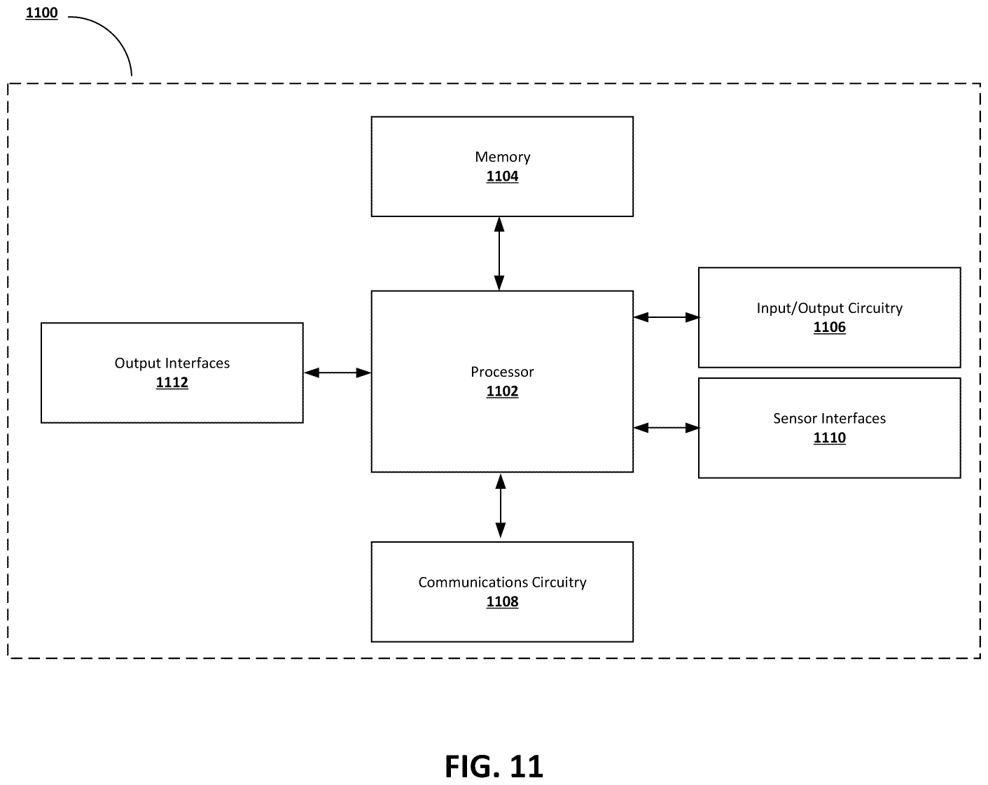

An example architecture for the audio signal processing apparatus 101 is depicted in the apparatus 1100 of FIG. 11. As depicted in FIG. 11, the apparatus 1100 includes processor 1102, memory 1104, input/output circuitry 1106, communications circuitry 1108, sensor interfaces 1110, and output interfaces 1112. Although these components 1102-1112 are described with respect to functional limitations, it should be understood that the particular implementations necessarily include the use of particular hardware. It should also be understood that certain of these components 1102-1112 may include similar or common hardware. For example, two sets of circuitries may both leverage use of the same processor, network interface, storage medium, or the like to perform their associated functions, such that duplicate hardware is not required for each set of circuitries.

The processor 1102 (and/or co-processor or any other processing circuitry assisting or otherwise associated with the processor) may be in communication with the memory 1104 via a bus for passing information among components of the apparatus. The memory 1104 is non-transitory and may include, for example, one or more volatile and/or non-volatile memories. In other words, for example, the memory 1104 may be an electronic storage device (e.g., a computer-readable storage medium). The memory 1104 may be configured to store information, data, content, applications, instructions, or the like for enabling the apparatus to carry out various functions in accordance with example embodiments of the present disclosure.

The processor 1102 may be embodied in a number of different ways and may, for example, include one or more processing devices configured to perform independently. In some preferred and non-limiting embodiments, the processor 1102 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

The processor 1102 may be a central processing unit (CPU), a microprocessor, a coprocessor, a digital signal processor (DSP), an Advanced RISC Machine (ARM), a field programmable gate array (FPGA), a controller, or a processing element. The processor 1102 may also be embodied in various other processing circuitry including integrated circuits such as, for example, a microcontroller unit (MCU), an ASIC (application specific integrated circuit), a hardware accelerator, or a special-purpose electronic chip. Furthermore, the processor 1102 may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading.

The processor 1102 may be configured to execute instructions stored in the memory 1104 or otherwise accessible to the processor 1102. The processor 1102 may be configured to execute hard-coded functionalities. As such, whether configured by hardware or software methods, or by a combination thereof, the processor 1102 may represent an entity (e.g., physically embodied in circuitry) capable of performing operations according to an embodiment of the present disclosure while configured accordingly. Alternatively, as another example, when the processor 1102 is embodied as an executor of software instructions, the instructions may specifically configure the processor 1102 to perform the algorithms and/or operations described herein when the instructions are executed.

The apparatus 1100 may include input/output circuitry 1106 that may, in turn, be in communication with processor 1102 to provide output to the user and may receive an indication of a user input. The input/output circuitry 1106 may comprise a user interface and may include a display, and may comprise a web user interface, a mobile application, a client device, a kiosk, or the like. The input/output circuitry 1106 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 1104, and/or the like).

The communications circuitry 1108 may be any means such as a device or circuitry embodied in either hardware or a combination of hardware and software that is configured to receive and/or transmit data from/to a network and/or any other device, circuitry, or module in communication with the apparatus 1100. In this regard, the communications circuitry 1108 may include, for example, a network interface for enabling communications with a wired or wireless communication network.

The sensor interfaces 1110 may be configured to receive audio signals from the capture devices 102a-e. Examples of capture devices 102a-e include audio capture device, a microphone, a vision device, a video capture device, an infrared device, an ultrasound device, a radar device, a light detecting and ranging (LiDAR) device, or a combination thereof. The audio capture devices can include microphones (including wireless microphones) and wireless audio receivers. Wireless audio receivers, wireless microphones, and other wireless audio sensors typically include antennas for transmitting and receiving radio frequency (RF) signals which contain digital or analog signals, such as modulated audio signals, data signals, and/or control signals. A wireless audio receiver may be configured to receive RF signals from one or more wireless audio transmitters over one or more channels and corresponding frequencies. For example, a wireless audio receiver may have a single receiver channel so that the receiver is able to wirelessly communicate with one wireless audio transmitter at a corresponding frequency. As another example, a wireless audio receiver may have multiple receiver channels, where each channel can wirelessly communicate with a corresponding wireless audio transmitter at a respective frequency.

The output interfaces 1112 may be configured to provide generated audio samples to output devices 103. Examples of output devices 103 include wireless audio transmitters that are configured to transmit a signal, carrier wave, or the like to one or more audio receivers. The output devices 103 are configured to receive one or more adjustment signals from the audio signal processing apparatus 101 and perform adjustment operations (e.g., beam forming) based at least in part on the received adjustment signals.

In some embodiments, the communications circuitry 1108 may include one or more network interface cards, antennae, buses, switches, routers, modems, and supporting hardware and/or software, or any other device suitable for enabling communications via a network. Additionally or alternatively, the communications circuitry 1108 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 1100. One or more external systems (such as a remote cloud computing and/or data storage system) may also be leveraged to provide at least some of the functionality discussed herein.

With respect to components of the apparatus 1100, the term “circuitry” as used herein and defined above should therefore be understood to include particular hardware configured to perform the functions associated with the particular circuitry as described herein. For example, in one embodiment, “circuitry” may include processing circuitry, storage media, network interfaces, input/output devices, and the like. In one embodiment, other elements of the apparatus 1100 may provide or supplement the functionality of particular circuitry. For example, the processor 1102 may provide processing functionality, the memory 1104 may provide storage functionality, the communications circuitry 1108 may provide network interface functionality, and the like. Similarly, other elements of the apparatus 1100 may provide or supplement the functionality of particular circuitry.

As will be appreciated, any such computer program instructions and/or other type of code may be loaded onto a computer, processor or other programmable apparatus's circuitry to produce a machine, such that the computer, processor or other programmable circuitry that execute the code on the machine creates the means for implementing various functions, including those described herein.

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Additional Implementation Details

Although example processing systems have been described in herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a device is described herein to receive data from another device, it will be appreciated that the data may be received directly from another device or may be received indirectly via one or more intermediary devices, such as, for example, one or more servers, relays, routers, network access points, base stations, hosts, and/or the like (sometimes referred to herein as a “network”). Similarly, where a device is described herein to send data to another device, it will be appreciated that the data may be sent directly to another device or may be sent indirectly via one or more intermediary devices, such as, for example, one or more servers, relays, routers, network access points, base stations, hosts, and/or the like.

The term “circuitry” should be understood broadly to include hardware and, in some embodiments, software for configuring the hardware. With respect to components of the apparatus, the term “circuitry” as used herein should therefore be understood to include particular hardware configured to perform the functions associated with the particular circuitry as described herein. For example, in some embodiments, “circuitry” may include processing circuitry, storage media, network interfaces, input/output devices, and the like.

The term “user” should be understood to refer to an individual, group of individuals, business, organization, and the like. The users referred to herein may access a group-based communication platform using client devices (as defined herein).

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising one or more processors and one or more memories storing instructions that are operable, when executed by the one or more processors, to cause the apparatus to receive, from one or more capture devices arranged within at least one physical enclosure, a plurality of audio signals. The apparatus may further be caused to extract, from the plurality of audio signals, at least one of: a sound localization event or a sound classification event. The apparatus may further be caused to determine, based at least in part on the at least one sound localization event or sound classification event, one or more: characteristics associated with the physical enclosure. The apparatus may further be caused to adjust, based at least in part on the one or more characteristics, one or more parameters of the one or more capture devices.

Clause 2. An apparatus according to Clause 1, wherein the one or more characteristics associated with the physical enclosure comprise characteristics of the physical enclosure, characteristics of objects within the physical enclosure, or characteristics of audio sources within the physical enclosure.

Clause 3. An apparatus according to any of the preceding Clauses, wherein the one or more memories store instructions that are operable, when executed by the one or more processors, to further cause the apparatus to generate, based at least in part on the at least one sound localization event or sound classification event, at least one structured audio event data set.

Clause 4. An apparatus according to any of the preceding Clauses, wherein the one or more memories store instructions that are operable, when executed by the one or more processors, to further cause the apparatus to: determine, using an audio event framework and based at least in part on the at least one structure audio event data set, the one or more characteristics associated with the physical enclosure.

Clause 5. An apparatus according to any of the preceding Clauses, wherein the at least one structured audio event data set comprises a histogram.

Clause 6. An apparatus according to any of the preceding Clauses, wherein adjusting the one or more parameters of the one or more capture devices comprises adjusting positions of the one or more capture devices or adjusting processing parameters associated with processing the plurality of audio signals.

Clause 7. An apparatus according to any of the preceding Clauses, wherein the at least one structured audio event data set comprises a plurality of audio event data points and is characterized by a corresponding structured audio event type.

Clause 8. An apparatus according to any of the preceding Clauses, wherein the structured audio event type comprises a temporal audio event type or a volumetric audio event type, wherein a temporal audio event type is associated with audio events occurring over a time window and wherein a volumetric audio event type is associated with audio events occurring associated with physical dimensions of the at least one physical enclosure.

Clause 9. An apparatus according to any of the preceding Clauses, wherein the one or more memories store instructions that are operable, when executed by the one or more processors, to further cause the apparatus to associate a sound classification event with a sound localization event, and generate the at least one structured audio event data set based at least in part on the sound localization event and associated sound classification event.

Clause 10. An apparatus according to any of the preceding Clauses, wherein the audio event framework comprises one or more digital signal processing (DSP) models configured to generate, based at least in part on the at least one structured audio event data set, an individual characteristic indicative of the one or more characteristics.

Clause 11. An apparatus according to any of the preceding Clauses, wherein the audio event framework comprises one or more characteristic prediction models that are configured to generate, based at least in part on the at least one structured audio event data set, an individual characteristic indicative of the one or more characteristics.

Clause 12. An apparatus according to any of the preceding Clauses, wherein each characteristic prediction model is configured to determine an individual characteristic corresponding to a characteristic type.

Clause 13. An apparatus according to any of the preceding Clauses, wherein the audio event framework further comprises a combinatorial audio event model that is configured to: determine, based at least in part on process each individual characteristic, the one or more characteristics associated with the physical enclosure.

Clause 14. An apparatus according to any of the preceding Clauses, wherein the audio event framework further comprises a digital signal processing (DSP) model that is configured to: determine, based at least in part on process each individual characteristic, the one or more characteristics associated with the physical enclosure.

Clause 15. An apparatus according to any of the preceding Clauses, wherein the audio event framework further comprises a combinatorial audio event model that is configured to: determine, based at least in part on process each individual characteristic, the one or more characteristics associated with the physical enclosure.

Clause 16. An apparatus according to any of the preceding Clauses, wherein the audio event framework further comprises a second digital signal processing (DSP) model that is configured to: determine, based at least in part on process each individual characteristic, the one or more characteristics associated with the physical enclosure.

Clause 17. An apparatus according to any of the preceding Clauses, wherein the one or more characteristics comprise one or more shapes, centroids of common speech regions, boundaries of common speech regions, centroids of noise regions, boundaries of noise regions over one or more time windows, physical locations, or changes in physical locations over one or more time windows.

Clause 18. An apparatus according to any of the preceding Clauses, wherein the one or more memories store instructions that are operable, further cause the apparatus to generate a statistical summary.

Clause 19. An apparatus according to any of the preceding Clauses, wherein the statistical summary comprises the one or more characteristics, one or more sound localization event statistics, one or more sound classification event statistics, one or more sound event statistics, one or more physical enclosure characteristic predicted representations, or one or more structured audio event data set representations.

Clause 20. An apparatus according to any of the preceding Clauses, wherein the one or more capture devices comprise an audio capture device, a microphone, a vision device, a video capture device, an infrared device, an ultrasound device, a radar device, a light detecting and ranging (LiDAR) device, or a combination thereof.

Clause 21. An apparatus according to any of the preceding Clauses, further comprising a feature pre-processing model configured to extract the sound localization event or sound classification event from the plurality of audio signals.

Clause 22. An apparatus according to any of the preceding Clauses, further comprising a digital signal processing (DSP) model configured to extract the sound localization event or sound classification event from the plurality of audio signals.

Clause 23. A non-transitory computer readable storage medium storing instructions that are operable, when executed by one or more processors of an apparatus, to cause the apparatus to perform operations in accordance with any of the preceding Clauses.

Clause 24. A computer-implemented method, comprising operations in accordance with any of the preceding Clauses.

Clause 25. An apparatus comprising one or more processors and one or more memories storing instructions that are operable, when executed by the one or more processors, to cause the apparatus to receive audio signals from one or more capture devices arranged within at least one physical enclosure. The apparatus may further be caused to determine, based at least in part on a sound localization event or a sound classification event extracted from the audio signals, characteristics associated with the physical enclosure. The apparatus may further be caused to adjust, based at least in part on the characteristics, one or more parameters of the one or more capture devices.

### CONCLUSION

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising one or more processors and one or more memories storing instructions that are operable, when executed by the one or more processors, to cause the apparatus to:
receive, from one or more capture devices arranged within at least one physical enclosure, a plurality of audio signals;
extract, from the plurality of audio signals, at least one of: a sound localization event or a sound classification event;
determine, based at least in part on the at least one sound localization event or sound classification event, one or more: characteristics associated with the physical enclosure; and
adjust, based at least in part on the one or more characteristics, one or more parameters of the one or more capture devices.

2. The apparatus of claim 1, wherein the one or more characteristics associated with the physical enclosure comprise characteristics of the physical enclosure, characteristics of objects within the physical enclosure, or characteristics of audio sources within the physical enclosure.

3. The apparatus of claim 1, wherein the one or more memories store instructions that are operable, when executed by the one or more processors, to further cause the apparatus to:
generate, based at least in part on the at least one sound localization event or sound classification event, at least one structured audio event data set.

4. The apparatus of claim 3, wherein the one or more memories store instructions that are operable, when executed by the one or more processors, to further cause the apparatus to:
determine, using an audio event framework and based at least in part on the at least one structure audio event data set, the one or more characteristics associated with the physical enclosure.

5. The apparatus of claim 3, wherein the at least one structured audio event data set comprises a histogram.

6. The apparatus of claim 1, wherein adjusting the one or more parameters of the one or more capture devices comprises adjusting positions of the one or more capture devices or adjusting processing parameters associated with processing the plurality of audio signals.

7. The apparatus of claim 3, wherein the at least one structured audio event data set comprises a plurality of audio event data points and is characterized by a corresponding structured audio event type.

8. The apparatus of claim 7, wherein the structured audio event type comprises a temporal audio event type or a volumetric audio event type, wherein a temporal audio event type is associated with audio events occurring over a time window and wherein a volumetric audio event type is associated with audio events occurring associated with physical dimensions of the at least one physical enclosure.

9. The apparatus of claim 3, wherein the one or more memories store instructions that are operable, when executed by the one or more processors, to further cause the apparatus to:
associate a sound classification event with a sound localization event; and
generate the at least one structured audio event data set based at least in part on the sound localization event and associated sound classification event.

10. The apparatus of claim 4, wherein the audio event framework comprises one or more digital signal processing (DSP) models configured to generate, based at least in part on the at least one structured audio event data set, an individual characteristic indicative of the one or more characteristics.

11. The apparatus of claim 4, wherein the audio event framework comprises one or more characteristic prediction models that are configured to generate, based at least in part on the at least one structured audio event data set, an individual characteristic indicative of the one or more characteristics.

12. The apparatus of claim 11, wherein each characteristic prediction model is configured to determine an individual characteristic corresponding to a characteristic type.

13. The apparatus of claim 10, wherein the audio event framework further comprises:
a combinatorial audio event model that is configured to: determine, based at least in part on process each individual characteristic, the one or more characteristics associated with the physical enclosure.

14. The apparatus of claim 10, wherein the audio event framework further comprises:
a digital signal processing (DSP) model that is configured to: determine, based at least in part on process each individual characteristic, the one or more characteristics associated with the physical enclosure.

15. The apparatus of claim 11, wherein the audio event framework further comprises:
a combinatorial audio event model that is configured to: determine, based at least in part on process each individual characteristic, the one or more characteristics associated with the physical enclosure.

16. The apparatus of claim 11, wherein the audio event framework further comprises:
a second digital signal processing (DSP) model that is configured to: determine, based at least in part on process each individual characteristic, the one or more characteristics associated with the physical enclosure.

17. The apparatus of claim 2, wherein the one or more characteristics comprise one or more shapes, centroids of common speech regions, boundaries of common speech regions, centroids of noise regions, boundaries of noise regions over one or more time windows, physical locations, or changes in physical locations over one or more time windows.

18. The apparatus of claim 1, wherein the one or more memories store instructions that are operable, further cause the apparatus to:
generate a statistical summary.

19. The apparatus of claim 18, wherein the statistical summary comprises the one or more characteristics, one or more sound localization event statistics, one or more sound classification event statistics, one or more sound event statistics, one or more physical enclosure characteristic predicted representations, or one or more structured audio event data set representations.

20. The apparatus of claim 1, wherein the one or more capture devices comprise an audio capture device, a microphone, a vision device, a video capture device, an infrared device, an ultrasound device, a radar device, a light detecting and ranging (LiDAR) device, or a combination thereof.

21. The apparatus of claim 1, further comprising a feature pre-processing model configured to extract the sound localization event or sound classification event from the plurality of audio signals.

22. The apparatus of claim 1, further comprising a digital signal processing (DSP) model configured to extract the sound localization event or sound classification event from the plurality of audio signals.

23-24. (canceled)

25. An apparatus comprising one or more processors and one or more memories storing instructions that are operable, when executed by the one or more processors, to cause the apparatus to:
receive audio signals from one or more capture devices arranged within at least one physical enclosure;
determine, based at least in part on a sound localization event or a sound classification event extracted from the audio signals, characteristics associated with the physical enclosure; and
adjust, based at least in part on the characteristics, one or more parameters of the one or more capture devices.
